(19) United States
(12) Patent Application Publication
(10) Pub. No.: US 2009/0109488 A1
(43) Pub. Date: Apr. 30, 2009

(54) Method of printing photograph and advertisement using photo-printer

(75) Inventor: Sung-ha Park, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/156,886

(22) Filed: Jun. 5, 2008

(30) Foreign Application Priority Data
Oct. 31, 2007 (KR) 10-2007-0110245

(51) Int. Cl. G06K 15/00

(52) U.S. Cl. 358/1.18

(57) ABSTRACT

Provided is a method of printing a photograph and an advertisement via a photo-printer by using a photograph/advertisement printing system, wherein the advertisement is printed on outer portions of a printing paper, which are portions of the paper on which the photograph is not printed. The method includes: preparing an image file in which an image is stored and an advertisement file in which the advertisement is stored; and combining the image file and the advertisement file into an output file and constructing contents of the output file such that the advertisement is printed on an outer portion of a printing paper used by the photo-printer during the printing of the photograph on the printing paper.

### CROSS-REFERENCE TO RELATED PATENT APPLICATION

This application claims the benefit of Korean Patent Application No. 10-2007-0110245, filed on Oct. 31, 2007, in the Korean Intellectual Property Office, the disclosure of which is incorporated herein in its entirety by reference.

### BACKGROUND OF THE INVENTION

1. Field of the Invention

The present invention relates generally to a method of printing a photograph using a photo-printer, and more particularly, to a method of printing both a photograph and an advertisement on the same printing paper.

2. Description of the Related Art

With the development and rapid spread of digital cameras, it is common for many people to take photographs using the digital cameras. After taking photographs with digital cameras, photographers may store digital images of the taken photographs and/or print the photographs on printing papers using photo-printers.

FIG. 1 illustrates a conventional printing paper 101 on which a photograph is printed using a photo-printer.

Referring to FIG. 1, the conventional printing paper 101 is divided into an inner portion 111 (which is the central area of the paper) on which the photograph is printed and outer portions 121 and 122 (which are right and left side areas adjacent to the central area) on which the photograph is not printed, as demarcated by right and left dash lines 131.

The inner portion 111, which is demarcated from the outer portions 121 and 122 by the dash lines 131, is used for printing the photograph thereon, while the outer portions 121 and 122 are not used to print the photograph thereon. Accordingly, the outer portions 121 and 122 are cut along the dash lines 131 and 132 and discarded after the photograph is printed.

### SUMMARY OF THE INVENTION

The present invention provides a method of printing a photograph and an advertisement on the same sheet of printing paper, wherein the advertisement is printed on outer portions of the printing paper—that is, side or edge areas on which a photograph is not printed.

According to an aspect of the present invention, there is provided a method of printing a photograph and an advertisement using a photograph/advertisement printing apparatus via a photo-printer. The method includes: preparing an image file in which an image is stored and an advertisement file in which the advertisement is stored; and combining the image file and the advertisement file into an output file and constructing contents of the output file such that the advertisement is printed on an outer portion of a printing paper, which is used by the photo-printer during the printing of the photograph on the printing paper.

According to another aspect of the present invention, there is provided a method of printing a photograph and an advertisement via a photo-printer by using a server in an photograph/advertisement printing system including the server in which data is stored and a personal computer (PC) to which the photo-printer is connected. In the photograph/advertisement printing system, the server and the PC are connected to each other via an Internet. The method includes: preparing an image file in which an image is stored and an advertisement file in which the advertisement is stored; providing menus for printing the photograph to the PC; combining the image file and the advertisement file into an output file when the PC selects one of the menus, and constructing contents of the output file such that the advertisement is printed on an outer portion of a printing paper used by the photo-printer for printing the photograph on the printing paper; and transmitting the output file to the PC.

According to yet another aspect of the present invention, there is provided a method of printing a photograph and an advertisement via a photo-printer by using a personal computer (PC) in a photograph/advertisement printing system including a server in which data is stored and the PC to which the photo-printer is connected. In the photograph/advertisement printing system, the server and the PC are connected to each other via an Internet. The method includes: preparing an image file in which an image is stored and an advertisement file in which the advertisement transmitted from the server is stored; displaying menus for printing the photograph; combining the image file and the advertisement file into an output file when a user selects one of the menus, and constructing contents of the output file such that the advertisement is printed on an outer portion of a printing paper used by the photo-printer for printing the photograph on the printing paper; and transmitting the output file to the photo-printer.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional printing paper on which a photograph is printed using a photo-printer;

FIG. 2 is a block diagram of a photograph/advertisement printing apparatus according to an embodiment of the present invention;

FIG. 3 is a flowchart of a method of printing a photograph and an advertisement using the apparatus shown in FIG. 2;

FIG. 4 illustrates a printing paper on which a photograph and an advertisement are printed, according to an embodiment of the present invention;

FIG. 5 is a block diagram of a photograph/advertisement printing system according to an embodiment of the present invention;

FIG. 6 is a flowchart of a method of printing a photograph and an advertisement using a photo gallery server shown in FIG. 5;

FIG. 7 is a flowchart of a method of printing a photograph and an advertisement using a personal computer (PC) shown in FIG. 5;

FIG. 8 is a block diagram of a photograph/advertisement printing system according to another embodiment of the present invention; and

FIG. 9 is a flowchart of a method of printing a photograph and an advertisement using a photo-printer shown in FIG. 8.

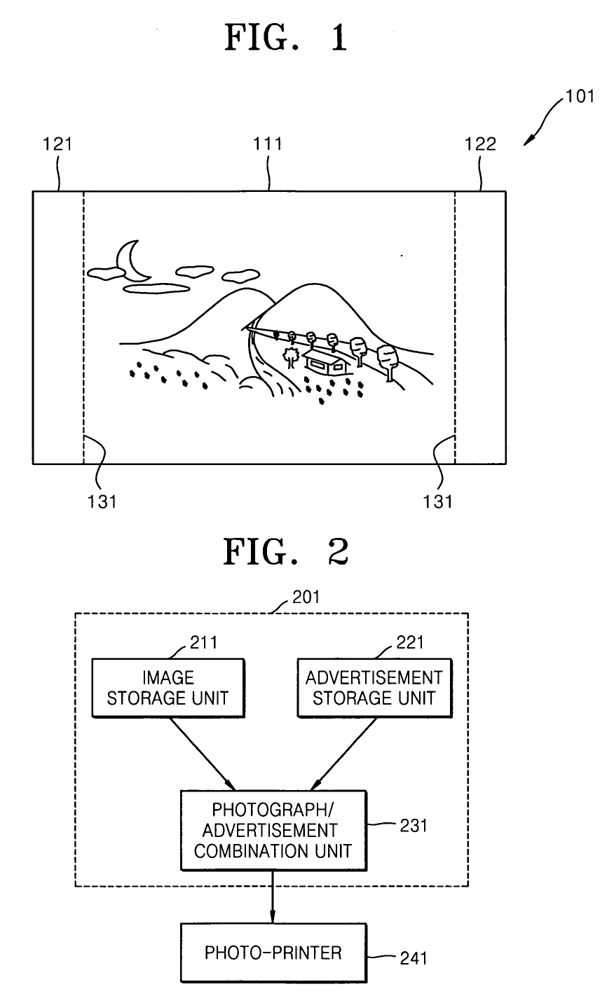

### DETAILED DESCRIPTION OF THE INVENTION

The present invention will be described more fully hereinafter with reference to the accompanying drawings, in which example embodiments of the invention are shown. In the drawings, like reference numerals are used to denote like features.

FIG. 2 is a block diagram of a photograph/advertisement printing apparatus 201 according to an embodiment of the present invention.

Referring to FIG. 2, the photograph/advertisement printing apparatus 201 includes an image storage unit 211, an advertisement storage unit 221, and a photograph/advertisement combination unit 231.

The image storage unit 211 stores image files, where an image file includes digital information (e.g., pixel information) which can be reproduced or rendered as an image of a photographed subject or object.

The advertisement storage unit 221 stores advertisement files, where an advertisement included in an advertisement file is comprised of alphanumeric characters, images, or a combination of characters and images.

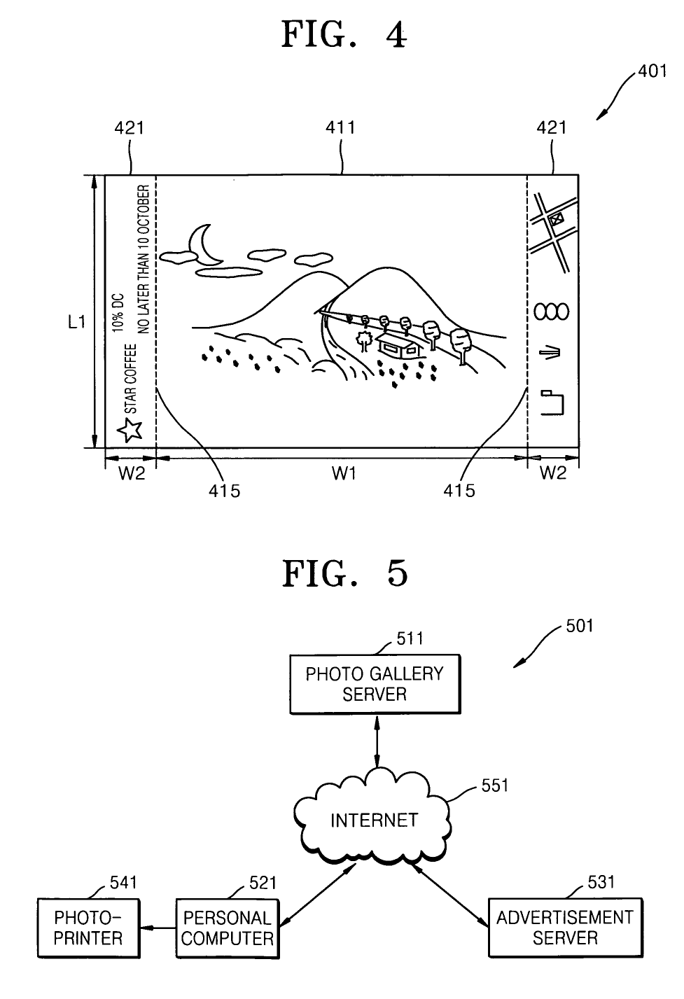

The photograph/advertisement combination unit 231 receives the image file transmitted from the image storage unit 211 and the advertisement file transmitted from the advertisement storage unit 221 and combines the image file and the advertisement file into an output file. That is, the photograph/advertisement combination unit 231 generates or otherwise configures the content of the output file such that when a photograph is printed, the photograph and an advertisement are printed on the same sheet of printing paper 401 (FIG. 4), which is used by a photo-printer 241. As shown in FIG. 4, the advertisement is printed on both outer portions 421 (defined to be exterior to dash lines 415) of the printing paper 401, and the photograph is printed in an inner portion (defined to be interior to the dash lines 415) of the printing paper 401.

The printing paper 401 used by the photo-printer 241 includes the dash lines 415 (refer to FIG. 4) disposed on both sides thereof. Thus, a photograph can be printed on the inner portion of the printing paper 401, while an advertisement can be printed on the outer portions of the printing paper 401.

The photograph/advertisement printing apparatus 201 may be included in a photo gallery server 511 (refer to FIG. 5), a photo-printer 841 (refer to FIG. 8), or a personal computer (PC) 521 (refer to FIG. 5).

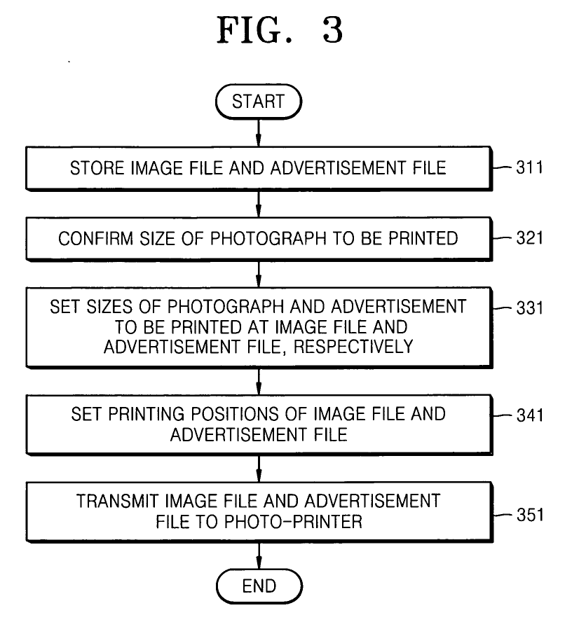

FIG. 3 is a flowchart of a method of printing a photograph and an advertisement using the photograph/advertisement printing apparatus 201 shown in FIG. 2. Hereinafter, the method of printing a photograph and an advertisement will be described with reference to FIGS. 2 and 3.

In operation 311, the photograph/advertisement printing apparatus 201 stores an image file and an advertisement file. As shown in FIG. 2, the photograph/advertisement printing apparatus 201 may store the image file in the image storage unit 211 and the advertisement file in the advertisement storage unit 221. The image storage unit 211 and the advertisement storage unit 221 may receive the image file and the advertisement file via the Internet or from an external apparatus such as a digital camera, a PDA, a laptop, and a computer-readable medium including a CD, DVD or flash memory.

In operation 321, the photograph/advertisement unit 231 confirms a size (e.g., refer to L1×W1 shown in FIG. 4) of a photograph to be printed, which is set at the photo-printer 241. In order to set the size (L1×W1) of the photograph to be printed, a user of the photograph/advertisement printing apparatus 201 may input a desired size to the photograph/advertisement printing apparatus 201 or the photo-printer 241. The size of the photograph to be printed may be variously set. Presently, a photograph size having a length L1 of 4 inches and a width W1 of 6 inches is being widely used in the art. Thus, it is unnecessary to separately confirm a size of an advertisement (L1×W2), which is set at the photo-printer 241, because the size of the advertisement may be automatically determined (e.g., relative to a 4×6 default or standard setting for the photograph). When only one size of the photograph to be printed is used, such one size of the photograph is set as a default. When various (e.g., a plurality of) printing sizes are available as choices, a user may select one of the sizes whenever the user prints the photograph.

In operation 331, the photograph/advertisement combination unit 231 sets the size of the photograph to be printed and the size of the advertisement to be printed in the image file and the advertisement file, respectively. When the size of the photograph is changed, the length L1 and the width W1 may not be changed in a ratio of 1:1. For example, when the size of the photograph is changed from 3×4 to 4×6, the length L1 increases by 1.33 times, while the width W1 increases by 1.5 times. In other words, when the size of the photograph is changed, the length L1 and the width W1 may be changed in different rates. Accordingly, when the size of the photograph is changed, the photograph/advertisement combination unit 231 calculates respective change rates of the length L1 and the width W1 and sets the image file and the advertisement file according to the calculated change rates of the length L1 and the width W1. When the image file and the advertisement file are combined into a single output file, the size of the photograph and the size of the advertisement may be adjusted, varied or otherwise configured according to an additional command stored to the output file such that the photograph and the advertisement are printed in response to the command. In other instances, the photograph/advertisement combination unit 231 may omit the previously-mentioned calculation operation. That is, the photograph/advertisement combination unit 231 may previously store the length L1 and the width W1 corresponding to the size of the photograph, fetch the previously-stored size data if necessary, and use the data.

In operation 341, the photograph/advertisement combination unit 231 sets positions of the photograph and the advertisement to be printed in the image file and the advertisement file, respectively. That is, when the photo-printer 241 prints the photograph and the advertisement on a printing paper, the photograph/advertisement combination unit 231 sets positions of the photograph and the advertisement such that the advertisement is printed on the outer portions 421, which are outside the dash lines 415, as shown in FIG. 4. When the image file and the advertisement file are combined into the single output file, the photograph/advertisement combination unit 231 may define the positions of the photograph and the advertisement as an additional command to the output file so that the photograph and the advertisement are printed in response to the command.

In operation 351, the photograph/advertisement combination unit 231 combines the image file and the advertisement file into the single output file and transmits the output file to the photo-printer 241. Thus, as shown in FIG. 4, the photo-printer 241 prints the photograph on an inner portion 411 of the paper 401 (inside the dash lines 415) and prints the advertisement on the outer portions 421 of the paper 401 (outside the dash lines 415).

As described above, when the photograph is printed on the printing paper 401 by the photo-printer 241, the user can see the advertisement printed on both the outer portions 421 of the printing paper 401, thereby advertising via the photograph.

In this case, since the advertisement is printed on the outer portions 421, outside the dash lines 415, the user may separate the advertisement from the photograph, for example by cutting along the dash lines 415. Therefore, the advertisement becomes no obstacle to the photograph, and the advertisement is independent from the photograph. In other embodiments, the paper 401 may include perforations, scoring or the like which facilitate separation of the advertisement from the photograph without having to use a cutting implement such as scissors.

FIG. 5 is a block diagram of a photograph/advertisement printing system 501 according to an exemplary embodiment of the present invention.

Referring to FIG. 5, the photograph/advertisement printing system 501 includes the photo gallery server 511, a personal computer (PC) 521, an advertisement server 531, and a photo-printer 541. The photo gallery server 511, the PC 521, and the advertisement server 531 communicate data with one another via the Internet 551. The system 501 may include a plurality of PCs 521 and a plurality of advertisement servers 531 which communicate with each other via the Internet 551.

The photo gallery server 511 includes a website, database or the like in which image files are stored. The photo gallery server 511 may receive image files from external sources so that the server 511 stores the image files and one or more advertisement files, which are received from the advertisement server 531. The photo gallery server 511 may combine the image file and the advertisement file and provide the combined file to the PC 521. Alternatively, the PC 521 may receive the advertisement file from the photo gallery server 511, combine the advertisement file with an image file stored in the PC 521, and output the combined file to the photo-printer 541. That is, as previously mentioned, the photograph/advertisement printing apparatus 201 (and, therefore, the combination unit 231) may be incorporated into at least one of the photo gallery server 511 and the PC 521.

When the advertisement is printed by the photo-printer 541 via the PC 521, the photo gallery server 511 may provide a specific benefit, for example, purchase points, monetary compensation (e.g., cash, check, credit, etc.), and the like in return for printing the advertisement via the PC 521. In an example, the per-photograph price of the photograph-printing service (provided by system 501) may be at least partially defrayed or subsidized by the advertiser or owner/manager of the advertisement server 531. In this way, a person printing a photograph (e.g., via a photo kiosk or Internet/on-line photo-printing service) may enjoy a reduced printing cost when photographs are printed together with one or more advertisements. In some instances the person printing the photograph may opt-out of having advertisements printed with their photographs such that a higher photo-printing cost is incurred by the user.

After the advertisement is printed by the photo-printer 541 via the PC 521, the photo gallery server 511 provides an itemized statement of the advertisement to the advertisement server 531. In some instances, the PC 521 or the server 511 may request compensation from the advertisement server 531 for the advertisement cost in return for printing the advertisements with the photographs.

The advertisement server 531 provides the advertisement file and the advertisement cost to the photo gallery server 511. The advertisement file and the advertisement cost may not be transmitted via the Internet 551 but directly transmitted to an operator of the photo gallery server 511 by an advertiser that operates the advertisement server 531.

The user may be registered as a member of the photo gallery server 511 via the PC 521 so that the user can access the photo gallery server 511 and print the photograph using the photo-printer 541. Furthermore, when printing the photograph and the advertisement, the PC 521 may transmit advertisement-printing start and end signals or the like to the photo gallery server 511 so that advertisements and compensation therefore may be reconciled.

The PC 521 may transmit the advertisement-printing start and end signals to the photo gallery server 511, and the photo gallery server 511 informs the advertisement server 531 of the advertisement-printing start and end signals, so that the advertiser that operates the advertisement server 531 can confirm that the advertisement is certainly transmitted to the user. That is, the advertiser can rely on the photo gallery server 511 to cooperate or otherwise facilitate reconciliation of advertisements and compensation.

The user can get a discount using the purchase points received from the photo gallery server 511, when purchasing a product provided by the advertiser. In other words, the user gets a discount from the advertiser so as to purchase a product in return for the printing of the advertisement. That is, in some instances the user may remove the advertisement from the photograph and use the advertisement as a discount coupon.

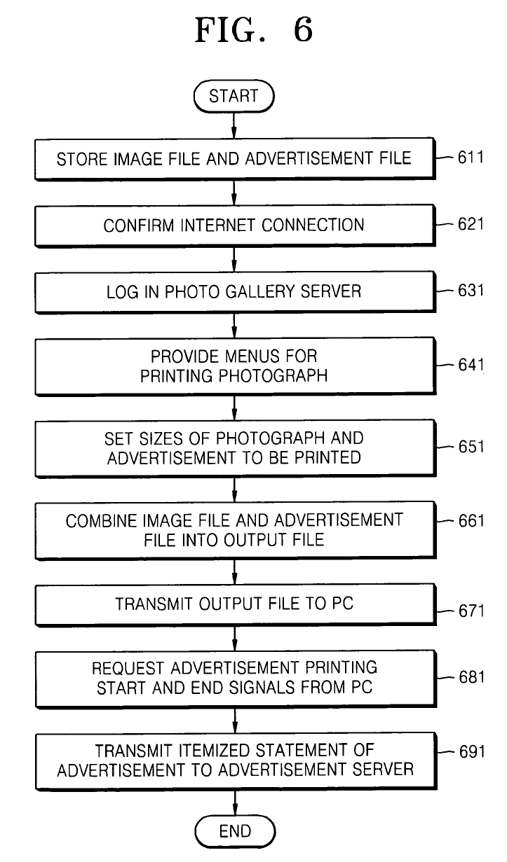

FIG. 6 is a flowchart of a method of printing a photograph and an advertisement using the photo gallery server 511 shown in FIG. 5. That is, in the embodiment of system 501, the photograph/advertisement printing apparatus 201 (and, therefore, the combination unit 231) is incorporated into the photo gallery server 511. Hereinafter, the method of printing a photograph and an advertisement will be described with reference to FIGS. 5 and 6.

In operation 611, the photo gallery server 511 stores an image file and an advertisement file. Specifically, the photo gallery server 511 stores an externally received image file and an advertisement file transmitted from the advertisement server 531. The photo gallery server 511 may store a plurality of image files, and a user may select an image file to be printed out of the plurality of image files via the PC 521. The photo gallery server 511 may store a plurality of advertisement files and select an advertisement file to be printed out of the plurality of advertisement files. The photo gallery server 511 may sort, categorize or otherwise configure or organize the advertisement files according to content (e.g., age, gender, region, and interest) and stores the sorted advertisement files. Accordingly, the photo gallery server 511 may select an advertisement suitable for user (e.g., according to the user's demographic information including age, gender, region, etc. and/or interest of the user), thereby advertising more effectively.

In operation 621, the photo gallery server 511 confirms its connection to the Internet 551. When the photo gallery server 511 is not properly connected to the Internet 551, signals cannot be properly transmitted via the Internet 551 so that the photo gallery server 511 cannot communicate signals to the PC 521 and the advertisement server 531.

In operation 631, the user logs in to the photo gallery server 511 via the PC 521. If the user is not able to log in the photo gallery server 511 via the PC 521, the photo gallery server 511 may not be able to transmit files to the PC 521 at the user's request. For the user to log in the photo gallery server 511 via the PC 521, the user may (in some instances) need to be registered as a member of the photo gallery server 511. In other instances, the user may be able to log in as an unregistered or guest user. In the case of registering as a member of the photo gallery server 511, the user provides personal information (e.g., a name, an address, an age, a gender, and interests) to the photo gallery server 511. Thereafter, the user uses an identification (ID) and a password as assigned by the photo gallery server 511 to log in the photo gallery server 511. As described above, the user provides personal information to the photo gallery server 511 so that the photo gallery server 511 can select an advertisement suitable for the user. In instances when the user is a guest or unregistered user, the server 511 may ask the user questions (e.g., via prompts) to ascertain demographic information or interests so that suitable advertisements may be provided. Alternatively, the server 511 may select general-interest advertisements for guest or unregistered users since these users’ demographics and interests are unknown.

In operation 641, the photo gallery server 511 provides menus for printing the photograph to the PC 521 so as to enable a user of the PC 521 to select one of the menus. The menus may include an image to be printed, the resolution of the photograph, the size of the photograph, and the number of prints. When the menus are not selected, the photo gallery server 511 may print the photograph based on default settings or menu items.

In operation 651, when the PC 521 selects the size of the photograph, the photo gallery server 511 sets the sizes of the photograph and advertisement to be printed at the image file and the advertisement file, respectively. Whenever the size of the photograph to be printed is changed, the photo gallery server 511 calculates a ratio of the length L1 to the width W1 of the photograph, and sets the sizes of the photograph and advertisement at the image file and the advertisement file, respectively. That is, when combining the image file and the advertisement file into a single output file, the sizes of the photograph and advertisement may be written as an additional command in the output file so that the photograph and the advertisement are printed in response to the command. In another case, the photo gallery server 511 may omit the calculation operation. That is, the photo gallery server 511 may previously store the length L1 and the width W1 corresponding to the size of the photograph, fetch stored data if necessary, and use the data.

In operation 661, the photo gallery server 511 combines the image file and the advertisement file into the output file such that the advertisement is printed on the outer portions 421, outside the dash lines 415 of the printing paper 401, as shown in FIG. 4. In other words, when producing the output file, the photo gallery server 511 may prepare printing positions of the photograph and the advertisement as an additional command and writes the additional command to the output file. In this case, the photo gallery server 511 may convert the image file and the advertisement file into respective images, configure the images (e.g., relative to user-requested size and the paper dimensions), and convert the images into a single output file. Alternatively, the photo gallery server 511 may combine the contents of the image file and the advertisement file into a single output file, issue an additional command to print the photograph and the advertisement, and add the additional command to the output file.

In operation 671, the photo gallery server 511 transmits the output file via the Internet 551 to the PC 521. Then, the PC 521 transmits the received output file to the photo-printer 541 so that the photograph and the advertisement are printed on the same sheet of paper (e.g., 401 shown in FIG. 4).

In operation 681, the photo gallery server 511 requests or queries the PC 521 for advertisement-printing start and end signals. In this way, the server 511 can verify completion of the advertisement printing.

In operation 691, the photo gallery server 511 transmits an itemized statement of the advertisement (or advertisements) which are printed to the advertisement server 531. That is, when the PC 521 receives the output file and starts printing the photograph and the advertisement via the photo-printer 541, the PC 521 transmits the advertisement-printing start and end signals to the photo gallery server 511, for example in real-time. Then, the photo gallery server 511 adds the advertisement-printing start and end signals and the advertisement cost caused by the printing of the advertisement to the itemized statement of the advertisement and transmits the an itemized statement of the advertisement to the advertisement server 531.

Thereafter, the photo gallery server 511 provides a specific benefit, for example, purchase points, to the user or owner of the PC 521 (or the user or operator of the printer 541) in return for the printing of the advertisement.

As stated above, the photo gallery server 511 enables the photo-printer 541 to print the advertisement, as well as the photograph, on the printing paper 401 so that the user may see the advertisement.

Accordingly, the advertiser effectively advertises, the photo gallery server 511 receives the advertisement cost from the advertisement server 531, and the PC 521 has a specific benefit in return for the printing of the advertisement.

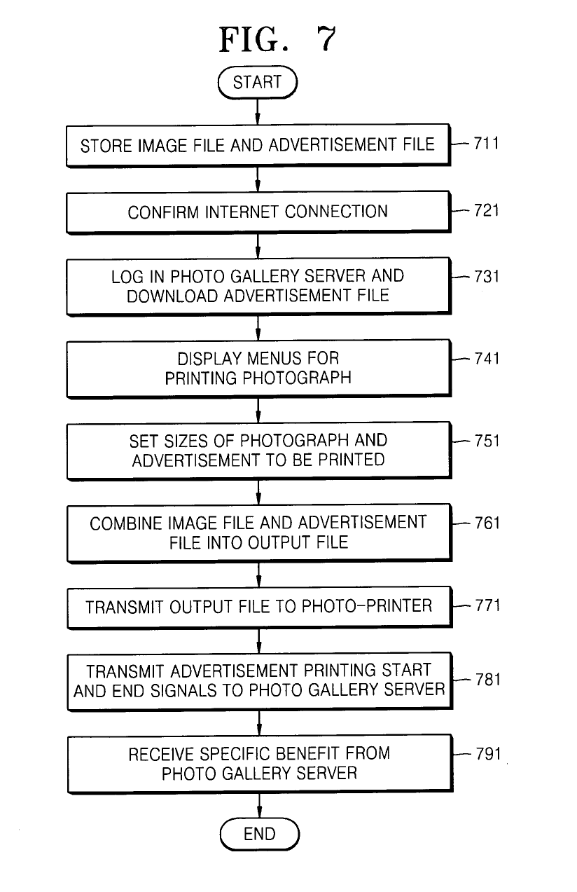

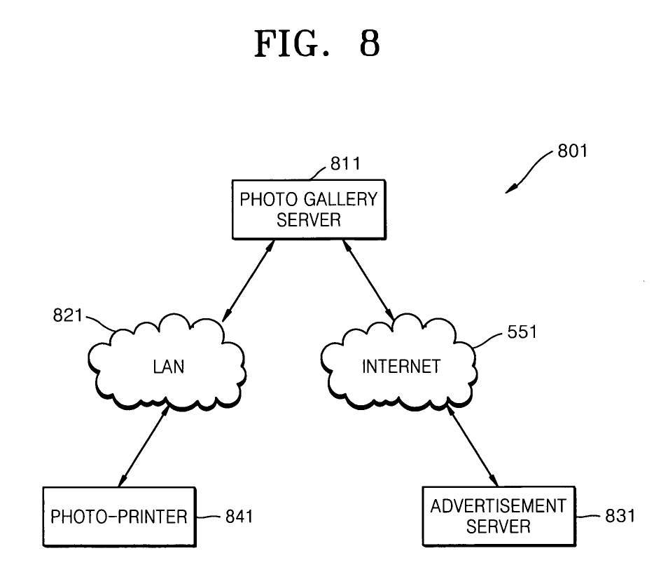

FIG. 7 is a flowchart of a method of printing a photograph and an advertisement using the PC 521 shown in FIG. 5. That is, in another embodiment of system 501, the photograph/advertisement printing apparatus 201 (and, therefore, the combination unit 231) is incorporated into the PC 521. Hereinafter, the method of printing the photograph and the advertisement will be described with reference to FIGS. 5 and 7.

In operation 711, the PC 521 stores an image file, and the photo gallery server 511 stores an advertisement file. The PC 521 receives the image file from an external apparatus (e.g., a memory card in which data is stored) and stores the image file. The photo gallery server 511 receives the advertisement file from the advertisement server 531 and stores the advertisement file. The PC 521 may store a plurality of image files, and the user may select an image file to be printed out of the plurality of image files. The photo gallery server 511 may store a plurality of advertisement files and select an advertisement file to be printed out of the plurality of advertisement files. The photo gallery server 511 may sort the advertisement files according to content (e.g., age, gender, region, and interest) and stores the sorted advertisement files. Accordingly, the photo gallery server 511 may select an advertisement suitable for the age, gender, region, and interest of the user, thereby advertising more effectively.

In operation 721, the PC 521 confirms connection its connection to the Internet 551. When the PC 521 is not properly connected to the Internet 551, signals cannot be properly transmitted via the Internet 551 so that the PC 521 cannot communicate signals to the photo gallery server 511. For instance, if the PC 521 is not properly connected to the Internet 551, the PC 521 cannot request an advertising file or advertising information from the server 511 and, therefore, the printer 541 cannot print a user-selected photograph with an advertisement on a common sheet of paper (e.g., 401 as shown in FIG. 4).

In operation 731, a user logs in the photo gallery server 511 via the PC 521 and downloads the advertisement file from the photo gallery server 511. If the user does not log in to the photo gallery server 511 via the PC 521, the PC 521 may not be able to download the advertisement file from the photo gallery server 511. In order for the user to log in the photo gallery server 511 via the PC 521, if may be preferred (but not necessary) for the user to be registered as a member of the photo gallery server 511 via the PC 521. In the case of registering as a member of the photo gallery server 511, the user provides personal information (e.g., a name, an address, an age, a gender, and interests) to the photo gallery server 511. Thereafter, the user uses an ID and a password as assigned by the photo gallery server 511 to log in photo gallery server 511. As described above, the user provides the personal information to the photo gallery server 511 so that the photo gallery server 511 can select an advertisement suitable for the user. However, as described previously with respect to operation 631 (FIG. 6), in other instances, the user may be able to log in as an unregistered or guest user.

In operation 741, the PC 521 displays menus for printing the photograph on a monitor (not shown) so as to enable the user to select one of the menus. The menus may include an image to be printed, the resolution of the photograph, the size of the photograph, and the number of prints. When the menus are not selected, the PC 521 may print the photograph based on menu items or contents set as defaults.

In operation 751, when the user selects the size of the photograph, the PC 521 sets the sizes of the photograph and advertisement to be printed at the image file and the advertisement file, respectively. Whenever the size of the photograph to be printed is changed, the PC 521 calculates a ratio of the length L1 to the width W1 of the photograph, and sets the sizes of the photograph and advertisement at the image file and the advertisement file, respectively. That is, when combining the image file and the advertisement file into a single output file, the sizes of the photograph and advertisement may be written as an additional command in the output file so that the photograph and the advertisement are printed in response to the command. In another case, the PC 521 may omit the calculation operation. That is, the PC 521 may previously store the length L1 and the width W1 corresponding to the size of the photograph, fetch stored data corresponding to the length L1 and the width W1, if necessary, and use the data.

In operation 761, the PC 521 combines the image file and the advertisement file into the output file such that the advertisement is printed on the outer portions 421, outside the dash lines 415 of the printing paper 401, as shown in FIG. 4. In other words, when producing the output file, the PC 521 may prepare printing positions of the photograph and the advertisement as an additional command and write the additional command to the output file. In this case, the PC 521 may convert the image file and the advertisement file into respective images, configure the images for printing, and convert the images into a single output file. Alternatively, the PC 521 may combine the contents of the image file and the advertisement file into a single output file, issue an additional command to print the photograph and the advertisement, and add the additional command to the output file.

In operation 771, the PC 521 transmits the output file to the photo-printer 541 so that the photograph and the advertisement are printed on the same piece or sheet of printing paper 401.

In operation 781, the PC 521 transmits advertisement-printing start and end signals to the photo gallery server 511, for example in real-time.

In operation 791, the user or owner of the PC 521 (or, additionally or alternatively, the user of owner of the printer 541) receives a specific benefit, for example, purchase points, from the photo gallery server 511 in return for the printing of the advertisement and stores the specific benefit.

Thereafter, the photo gallery server 511 transmits an itemized statement of the advertisement to the advertisement server 531. The photo gallery server 511 adds the advertisement printing start and end signals received from the PC 521 and the advertisement cost caused by the printing of the advertisement to the itemized statement of the advertisement and transmits the itemized statement of the advertisement to the advertisement server 531.

As stated above, the PC 521 enables the photo-printer 541 to print the advertisement, as well as the photograph, on the printing paper 401 so that the user may see the advertisement.

Accordingly, the advertiser effectively advertises, the photo gallery server 511 receives the advertisement cost from the advertisement server 531, and the PC 521 has a specific benefit in return for the printing of the advertisement.

FIG. 8 is a block diagram of a photograph/advertisement printing system 801 according to another embodiment of the present invention.

Referring to FIG. 8, the photograph/advertisement printing system 801 includes a photo gallery server 811, an advertisement server 831, and a photo-printer 841. The photo gallery server 811 is connected to the advertisement server 831 via the Internet 551 and connected to the photo-printer 841 via a local area network (LAN) 821. The Internet 551 may be connected to a plurality of advertisement servers 831.

The photo-printer 841 includes a memory (not shown) in which data is stored. thus, the photo-printer 841 externally receives and stores an image file in the memory and receives and stores an advertisement file from the advertisement server 831 in the memory. The photo-printer 841 combines the advertisement file and the image file to thereby print a photograph and an advertisement. In some instances the photo-printer 841 may include a user interface (e.g., a display and buttons, etc.) so that a user may display and select photographs to be printed, display menus, etc.

When the advertisement is printed by the photo-printer 841, the photo gallery server 811 may provide a specific benefit, for example, purchase points or monetary compensation, in return for the printing of the advertisement to the user or owner of the photo-printer 841.

After the advertisement is printed by the photo-printer 841, the photo gallery server 811 provides an itemized statement of the advertisement to the advertisement server 831 and requests the advertisement server 831 for the advertisement cost in return.

The advertisement server 831 provides the advertisement file and the advertisement cost to the photo gallery server 811. The advertisement file and the advertisement cost may be transmitted via the Internet 551. However, the advertisement file and the advertisement cost may, instead be directly transmitted to an operator of the photo gallery server 811 by an advertiser that operates the advertisement server 831.

When printing the photograph and the advertisement, the photo-printer 841 transmits advertisement-printing start and end signals to the photo gallery server 811.

As described previously with respect to FIGS. 6 and 7, the photo-printer 841 transmits the advertisement-printing start and end signals to the photo gallery server 811, and the photo gallery server 811 informs the advertisement server 831 of the advertisement-printing start and end signals, so that the advertiser that operates the advertisement server 831 can confirm that the advertisement is certainly transmitted to a user of the photo-printer 841. That is, the advertiser can rely on the photo gallery server 811.

The user of the photo-printer 841 can get a discount using the purchase points received from the photo gallery server 811 when purchasing a product provided by the advertiser. In other words, the user gets a discount from the advertiser so as to purchase a product in return for the printing of the advertisement.

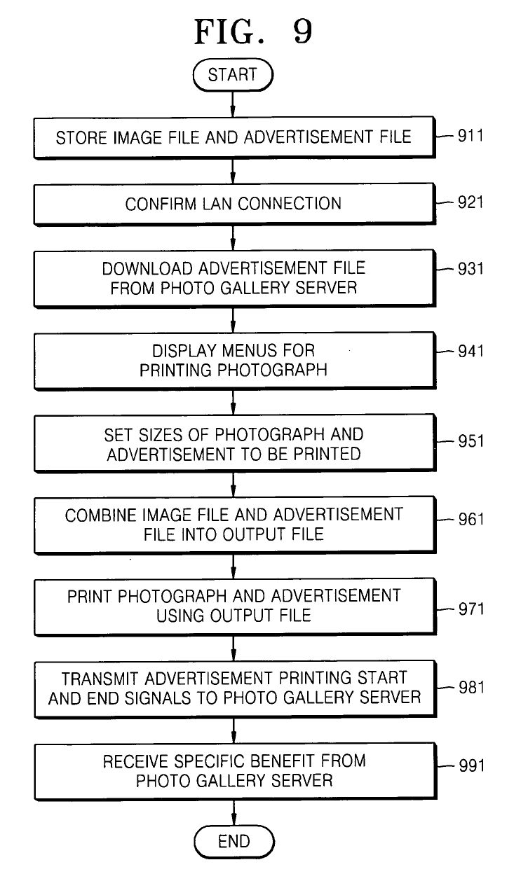

FIG. 9 is a flowchart of a method of printing a photograph and an advertisement using the system 801 including photo-printer 841 shown in FIG. 8. Hereinafter, the method of printing the photograph and the advertisement will be described with reference to FIGS. 8 and 9.

In operation 911, the photo-printer 841 stores an image file, and a photo gallery server 811 stores an advertisement file. The photo-printer 841 stores an externally received image file, while the photo gallery server 811 stores the advertisement file that is transmitted from the advertisement server 831. The photo-printer 841 may store a plurality of image files, and the user may select (e.g., using a printer user interface) an image file to be printed out of the plurality of image files. The photo gallery server 811 may store a plurality of advertisement files and select an advertisement file to be printed out of the plurality of advertisement files. The photo gallery server 811 may sort the advertisement files according to content (e.g., age, gender, region, and interest) and stores the sorted advertisement files. Accordingly, the photo gallery server 811 may select an advertisement suitable for the age, gender, region, and interest of the user of the printer 841 (or alternatively the content of the photograph being printed), thereby advertising more effectively.

In operation 921, the photo-printer 841 confirms its connection to the LAN 821. When the photo-printer 841 is not properly connected to the LAN 821, the photo-printer 841 may not be able to receive the advertisement file from the photo gallery server 811.

In operation 931, the photo-printer 841 downloads the advertisement file from the photo gallery server 811.

In operation 941, the photo-printer 841 displays menus (e.g., on a display screen or monitor of the printer's user interface) for printing the photograph so as to enable the user to select one of the menus. The menus may include an image to be printed, the resolution of the photograph, the size of the photograph, and the number of prints. When the menus are not selected, the photo-printer 841 may print the photograph based on menu items or contents set as defaults.

In operation 951, when the user selects the size of the photograph, the photo-printer 841 sets the sizes of the photograph and advertisement to be printed at the image file and the advertisement file, respectively. Whenever the size of the photograph to be printed is changed, the photo-printer 841 calculates a ratio of the length L1 to the width W1 of the photograph, and sets the sizes of the photograph and advertisement at the image file and the advertisement file, respectively. That is, when combining the image file and the advertisement file into a single output file, the sizes of the photograph and advertisement may be written as an additional command in the output file so that the photograph and the advertisement are printed in response to the command. In another case, the photo-printer 841 may omit the calculation operation. That is, the photo-printer 841 may previously store the length L1 and the width W1 corresponding to the size of the photograph, fetch stored data if necessary, and use the data.

In operation 961, the photo-printer 841 combines the image file and the advertisement file into the output file such that the advertisement is printed on the outer portions 421, outside the dash lines 415 of the printing paper 401, as shown in FIG. 4. In other words, when producing the output file, the photo-printer 841 may configure the photograph information and the advertisement information for printing. Alternatively, the printer 841 may configure positions of the photograph and the advertisement as an additional command and write the additional command to the output file. In this case, the photo-printer 841 may convert the image file and the advertisement file into respective images, dispose the images as shown in FIG. 4, and convert the images into a single output file. Alternatively, the photo-printer 841 may combine the contents of the image file and the advertisement file into a single output file, issue an additional command to print the photograph and the advertisement, and add the additional command to the output file.

In operation 971, the photo-printer 841 prints the photograph and the advertisement on the printing paper 401 by using the output file.

In operation 981, the photo-printer 841 transmits advertisement-printing start and end signals to the photo gallery server 811, for example in real-time.

In operation 991, the photo-printer 841 receives a specific benefit, for example, purchase points or monetary compensation, from the photo gallery server 811 in return for the printing of the advertisement and stores the specific benefit.

Thereafter, the photo gallery server 811 transmits an itemized statement of the advertisement to the advertisement server 831. The photo gallery server 811 adds the advertisement-printing start and end signals received from the photo-printer 841 and the advertisement cost caused by the printing of the advertisement to the itemized statement of the advertisement, and transmits the itemized statement of the advertisement to the advertisement server 831.

As stated previously, the photo-printer 841 prints the advertisement, as well as the photograph, on the printing paper 401 so that the user may see the advertisement.

Accordingly, the advertiser effectively advertises, the photo gallery server 811 receives the advertisement cost from the advertisement server 831, and the photo-printer 841 has a specific benefit in return for the printing of the advertisement.

According to the present invention as described above, when a photograph is printed on a printing paper used by a photo-printer, an advertisement is printed on outer portions, outside dash lines of the printing paper.

Thus, since the printing paper does not require additional space for the advertisement, an advertiser can effectively advertise without inconveniencing user.

When the method according to the present invention is applied to a photograph/advertisement printing system, an advertiser that uses an advertisement server can place an advertisement for products so that users of PCs and photo-printers can be informed of the products. Also, an operator of a photo gallery server can receive the advertisement cost from the advertiser in return for the advertisement, and the users can receive specific benefits in return for the printing of the advertisement.

Furthermore, a photo-printer transmits advertisement-printing start and end signals to the advertisement server, so that the advertiser can be convinced that the advertisement is certainly transmitted to a user of the photo-printer.

Moreover, the photo gallery server can select an advertisement, which is highly related with the user, out of a plurality of stored advertisements and provide the selected advertisement to the PC and the photo-printer, thereby advertising most effectively to the user.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of printing a photograph and an advertisement on a common sheet of printing paper using a photo-printer, the method comprising:
storing an image to be printed in an image file;
storing an advertisement to be printed in an advertisement file;
combining the image file and the advertisement file into an output file; and
configuring contents of the output file such that the advertisement is printed by the photo-printer on an outer portion of the printing paper during printing of the image on a inner portion of the printing paper.

2. The method of claim 1, further comprising:
transmitting the output file to the photo-printer; and
printing the photograph and the advertisement on a common sheet of printing paper.

3. The method of claim 1, wherein the configuring step comprises:
determining the sizes of the photograph and the advertisement to be printed using the photo-printer; and
adjusting image pixel information and advertisement pixel information in the output file according to the sizes of the photograph and the advertisement from the determining step.

4. The method of claim 1, further comprising the step of inserting into the photo-printer a sheet of printer paper having a dash line on a side thereof for demarcating the outer portion and the inner portion.

5. The method of claim 4, wherein the printing paper includes a second dash line for defining the inner portion between the first and second dash lines.

6. A method of printing a photograph and an advertisement on a common sheet of printing paper using a photograph/advertisement printing system including a photo-printer, a server, and a personal computer (PC), the method comprising:
storing in the server an image to be printed in an image file;
storing in the server an advertisement to be printed in an advertisement file;
displaying a menu on a display of the PC for user-customized printing of the image file;
combining the image file and the advertisement file into an output file stored in the server;
configuring contents of the output file such that the advertisement is printed by the photo-printer on an outer portion of the printing paper during printing of the image on a inner portion of the printing paper, the output file configured according to a menu item selected from the menu; and
transmitting the output file to the PC from the server.

7. The method of claim 6, wherein the configuring step comprises:
determining the sizes of the photograph and the advertisement to be printed using the photo-printer; and
adjusting image pixel information and advertisement pixel information in the output file according to the sizes of the photograph and the advertisement from the determining step.

8. The method of claim 6, further comprising:
sending the output file from the PC to the photo-printer; and
printing the photograph and the advertisement on a common sheet of printing paper.

9. The method of claim 8, wherein the printing step comprises transmitting advertisement-printing start and end signals from the PC to the server.

10. The method of claim 9, wherein the photograph/advertisement printing system includes an advertisement server, the method further comprising the step of the server receiving the advertisement from the advertisement server.

11. The method of claim 10, wherein the server receives the advertisement-printing start and end signals from the PC and transmits the advertisement-printing start and end signals to the advertisement server in real-time.

12. The method of claim 6, further comprising the step of inserting into the photo-printer a sheet of printer paper having a dash line on a side thereof for demarcating the outer portion and the inner portion.

13. The method of claim 9, further comprising the step of the server providing a specific benefit to a user of the PC according to the advertisement-printing start and end signals.

14. A method of printing a photograph and an advertisement on a common sheet of printing paper using a photograph/advertisement printing system including a photo-printer, a server, and a personal computer (PC), the method comprising:
the server transmitting to the PC an advertisement file;
storing the advertisement file in the PC;
storing an image file in the PC;
displaying a menu on a display of the PC for user-customized printing of the image file;
combining the image file and the advertisement file into an output file stored in the PC when a user selects a menu item from the menu;
configuring contents of the output file such that the advertisement is printed on an outer portion of the printing paper during the printing of the photograph on the printing paper; and
transmitting the output file from the PC to the photo-printer.

15. The method of claim 14, further comprising:
connecting a memory card which stores the image file with the PC; and
transferring the image file from the memory card to the PC.

16. The method of claim 14, wherein the transmitting step comprises:
printing the photograph and the advertisement on a common sheet of printing paper; and
communicating advertisement-printing start and end signals from the PC to the server after the photograph and the advertisement are printed on the printing paper.

17. The method of claim 16, wherein the photograph/advertisement printing system includes an advertisement server, and
wherein the server transmits the advertisement-printing start and end signals to the advertisement server in real-time.

18. The method of claim 14, further comprising the step of inserting into the photo-printer a sheet of printer paper having a dash line on a side thereof for demarcating the outer portion and the inner portion.

19. The method of claim 18, wherein the printing paper includes a second dash line for defining the inner portion between the first and second dash lines.

20. The method of claim 16, further comprising the step of the server providing a specific benefit to a user of the PC according to the advertisement-printing start and end signals.
